(19) United States
(12) Patent Application Publication
(10) Pub. No.: US 2026/0244487 A1
(43) Pub. Date: Aug. 20, 2026

(54) Application Start-Up and Shutdown

(71) Applicant: Telefonaktiebolaget LM Ericsson (publ), Stockholm (SE)

(72) Inventors: Erik Malmberg, Taberg (SE); Peter Cigéhn, Linköping (SE)

(21) Appl. No.: 19/160,907

(22) PCT Filed: Mar. 7, 2023
(86) PCT No.: PCT/EP2023/055693

§ 371 Date: Aug. 29, 2025

(51) Int. Cl. G06F 9/48

(52) U.S. Cl. CPC G06F 9/485

(57) ABSTRACT

A method for synchronizing the startup of applications. The method includes an initial application detecting an application launch event. The method also includes, in response to detecting the application launch event, the initial application starting a first instance of a proxy application. The method also includes the first instance of the proxy application sending a message for triggering a first starter to start a first worker application. The method also include the first starter starting the first worker application.

### TECHNICAL FIELD

Disclosed are embodiments related to starting-up and shutting-down applications in a synchronized manner.

### BACKGROUND

A network node, such as base station or a component of a base station (e.g., the control plane (CP) of the base station's central unit (CU)), typically comprises several applications that each run as a separate process (e.g., separate Linux processes), and one of these applications (the “initial” application) is responsible for both i) starting the other applications when a particular function (e.g., a gNB-CU-CP function) is configured and ii) shutting down the other applications when the function is removed. Conventionally, these other applications are started by fork and exec system calls and they are shut down using a signal (e.g., the “SIGTERM” signal).

In many scenarios, the network node will not function if all applications are started immediately because the subsequently started applications require that the services provided by the initial application are available when they start. Hence, starting all applications immediately in an unsynchronized way would lead to a race condition with intermittent failures due to which application that starts up the fastest. This means that in the many current implementations, the pattern of one application starting the other applications is needed from a functional perspective, not just to save compute resources.

In some implementations, service discovery is used to enable the initial application to find the other applications, which means that there is an application in which other applications can publish a service with a certain name and metadata (like for example a port and IP-address), and also subscribe to services based on the service name in order to retrieve the metadata for that service.

There is a desire to deploy some network nodes in the cloud, but an important difference in a cloud deployment is that the device's applications shall run in separate cloud containers, and it is not possible to use fork and exec system calls from one container to start a process in another container and it is not possible to use a SIGTERM signal from one container to shut down a process in another container.

One solution to solve the above described problem of synchronized start-up and shutdown of applications in a cloud deployment would be to use a Kubernetes operator that starts the containers in a synchronized way. But this is not the preferred solution. Another solution that could be used for the start-up and shutdown synchronization would be to use application-level messages. The applications could then be adapted to start immediately, but to halt their execution until they receive a message that indicates that they should proceed past this synchronization point. This, however, is also not a good solution.

### SUMMARY

Certain challenges presently exist. For instance, a drawback with the solution of using a Kubernetes operator to synchronize the start-up and shutdown of the applications is that it binds the implementation to a specific container platform (i.e., Kubernetes), which means that it must be modified to be able run on another container platform. The drawback with the solution of using application-level messages to synchronize the start-up and shutdown of the applications is that it requires additional communication channels to be set up between the applications, and additional messages to be sent between them. In the case of an implementation where one initial application starts many other applications, this would require a lot of additional communication channels to be set up and a lot of additional messages to be sent.

Accordingly, in one aspect there is provided a method for synchronizing the startup of applications. The method includes an initial application detecting an application launch event. The method also includes, in response to detecting the application launch event, the initial application starting a first instance of a proxy application. The method also includes the first instance of the proxy application sending a message for triggering a first starter to start a first worker application. The method also include the first starter starting the first worker application.

In another aspect there is provided a computer program comprising instructions which when executed by processing circuitry of a network node causes the network node to perform any of the methods disclosed herein. In one embodiment, there is provided a carrier containing the computer program wherein the carrier is one of an electronic signal, an optical signal, a radio signal, and a computer readable storage medium. In another aspect there is provided a network node that is configured to perform the methods disclosed herein. The network node may include memory and processing circuitry coupled to the memory.

An advantage of the embodiments disclosed herein is that the start-up of applications can be synchronized even if the initial application is not running within the same container or operating system as the other applications. Additionally, the embodiments do not require any additional communication channel be set up between the initial application and the applications that it starts, and they do not require any extra application-level messages to be sent between the initial application and the applications that it starts either.

### BRIEF DESCRIPTION OF THE DRAWINGS

The accompanying drawings, which are incorporated herein and form part of the specification, illustrate various embodiments.

FIG. 1 illustrates a network node according to some embodiments.

FIG. 2 is a signaling diagram according to some embodiments.

FIG. 3 is a flowchart illustrating a process according to some embodiments.

FIG. 4 shows an example of a communication system in accordance with some embodiments.

FIG. 5 is a block diagram of a network node according to some embodiments.

### DETAILED DESCRIPTION

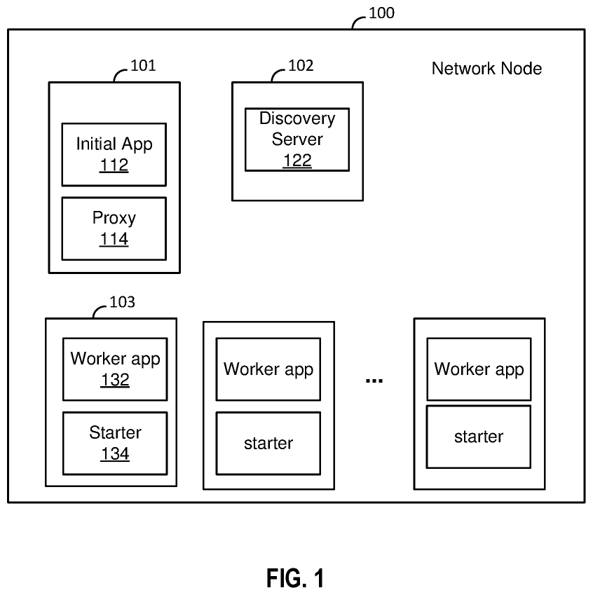

FIG. 1 illustrates a network node 100 according to an embodiment in which the network node is implemented using containers. Network node 100 includes: an initial container 101 (a.k.a., container A) in which an initial application 112 (a.k.a., Application A) and a proxy application 114 are configured to run; 2) a discovery service container 102 in which a discovery server 122 is configured to run; and 3) a worker container 103 in which a worker application 132 (a.k.a., Application B) and a starter 134 (a.k.a., Starter B) are configured to run. In practice, as shown in FIG. 1, network node may contain N additional worker containers (N>1) in which a worker application and a corresponding starter are configured to run. The containers shown in FIG. 1 may all run on top of the same hardware or on different hardware.

Initial application 112 may be configured to run as soon as container 101 is brought on line. Likewise, discovery server 122 and each starter (e.g., Starter B) are configured to run as soon as containers 102 and 103 are brought on line, respectively.

In one embodiment, initial application 112 is configured to start up the worker applications (e.g. Application B) using the fork( ) and exec( ) system calls. For example, in one embodiment, to start Application B, Application A calls fork and the resulting child process then calls exec, but instead of passing to the exec function the path and filename for Application B, the child process passes to the exec function the path and filename of proxy application 114 (and possible additional arguments), which then causes an instance of proxy application 114 to begin running. In this example, the first thing (or one of the first things) that proxy application 114 does is to send a message to discovery server 122, which triggers discovery server 122 to send a message to starter 134, which then launches Application B (e.g., starter 134 call fork and the resulting child process then calls exec to start Application B).

To shutdown Application B, Application A causes the operating system to send a certain signal (e.g., SIGTERM signal) to the instance of the proxy application 114 that Application A brought into existence via the exec call. When proxy application 114 detects the signal, proxy application sends a message to discovery server 122, which triggers discovery server 122 to send a message to starter 134, which then terminates Application B (e.g., starter 134 sends a SIGTERM signal to Application B).

As demonstrated above, the synchronization is done in such a way that the containers may be started without any synchronization (e.g. container 103 may be started before container 101) but the worker applications within a container are not started until initial application 112 takes a specific action to start the worker application.

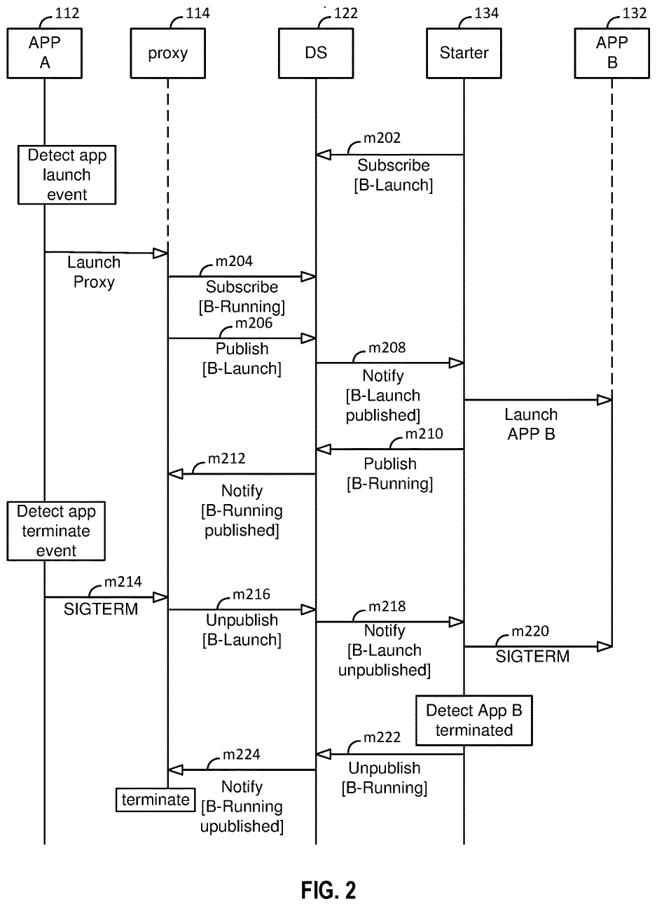

The proposed mechanism for service-discovery-controlled start-up and shutdown synchronization could be used for any worker application. However, FIG. 2 and the descriptions illustrates how Application A starts and stops Application B.

FIG. 2 shows an example signaling diagram. As shown in FIG. 2, Starter B sends a message m202 to discovery server 122. In this example, the message is a subscribe message that subscribes Starter B to a “B-Launch” service, which means that, whenever discovery server 122 receives a correspond publish message (i.e., a Publish “B-Launch” message), discovery server 122 sends to Starter B a notification message indicating that discovery server 122 has received a publish message corresponding to the subscribe message m202.

Next, an event (e.g. the creation of a particular function) is detected by Application A, which event is the trigger for Application A to launch at least Application B. Accordingly, in response to detecting the event, Application A creates at least one instance of a proxy application (e.g., proxy application 114) by, for example, using the fork and exec system calls as described above. For instance, Application A 112 may implement the following pseudo code:

```
int main(void) {
  ...
  event = detect_application_launch_event( )
  if (event = = TRUE) {
  if ((pid_B = fork( )) == 0)
    exec (″/bin/proxy″, ″/bin/proxy″, “B-Launch”, NULL)
  if ((pid_C = fork( )) == 0)
    exec (″/bin/proxy″, ″/bin/proxy″, “C-Launch”, NULL)
  . . .
  if ((pid_N = fork( )) == 0)
    exec (″/bin/proxy″, ″/bin/proxy″, “N-Launch”, NULL)
  }
  ...
}
```

In the example shown above, whenever an application launch event is detected, Application A launches N instances of proxy 114, where each instance is launched with a different argument.

In another embodiment, the pseudo code may look like this:

```
int main(void) {
  ...
event = detect_application_launch_event( )
if (event = = TRUE) {
    if ((pid_B = fork( )) == 0)
    exec (“/bin/App-B”, “/bin/App-B”, NULL, NULL)
    if ((pid_C = fork( )) == 0)
    exec (“/bin/App-C”, “/bin/App-C”, NULL, NULL)
  . . .
    if ((pid_N = fork( )) == 0)
      exec (“/bin/App-N”, “/bin/App-N”, NULL, NULL)
}
  ....
}
```

In the example above, files App-B, App-C, . . . , App-N are binary executable files, but the binary executable files App-B, App-C, . . . , App-N are not the binaries of the respective worker applications, but instead a binary for proxy 114 or a binary for a specify proxy for a specific application. For example, the binary stored in the file/bin/App-B is a binary of a proxy specifically for App-B (e.g., the binary may be hardcoded to send a Publish B-Launch message; likewise the binary stored in the file/bin/App-N is a binary of a proxy specifically for App-N (e.g., the binary may be hardcoded to send a Publish N-Launch message). In this way, N proxies are invoked in response to the detection of the application launch event.

In the example shown in FIG. 2, when an instance of a proxy gets invoked, the first things it does is send two messages to discovery server 122, a publish message m206 and a subscribe message m204. In one embodiment, the content of the publish and subscribe messages depends on the argument passed to the instance of the proxy or a parameter hard-coded in the proxy, as described above. So, for example, if the argument passed to the proxy is “B-Launch,” the content of the publish message m206 is “B-Launch” and the content of the subscribe message m204 is “B-Running.” Publish message m206 does not need any extra metadata to be published in service discovery in addition to the service name (i.e., “B-Launch”) because this service is only used to indicate that Application B should start up, so the only thing that needs to be published in service discovery is the name of the service (“B-Launch”). This is different to how service discovery is typically used when a service name is published together with some metadata (for example a port and IP-address) describing where that service can be reached.

In response to receiving Publish B-Launch message m206, discovery server 122 sends to starter 134 a notification message m208 informing starter 134 that the discovery server 122 has received a Publish B-Launch message. This notification from discovery server 122, triggers starter 134 to launch Application B. It is noted that Application A need not have any knowledge that it starts the Proxy Application instead of starting Application B. Starter 134 may start Application B with the fork and exec system calls, which is possible because they run in the same cloud container.

After Application B has been started, starter 134 publishes the “B-Running” service, which is detected by proxy 114. That is, for example, after starter 134 launches Application B, starter 134 sends to discovery server 122 a publish message m210 indicating that Application B has been launched. That is, starter sends a Publish B-Running message. Because proxy 114 has subscribed to the B-Running service, discovery server 122 will, in response to receiving the Publish B-Running message m210 from starter 134, send to proxy 114 a notification message m212 indicating that discovery server 122 has received a Publish B-Running message. This provides the notification to proxy 114 that Application B has been launched.

Accordingly, when proxy 114 starts up it subscribes to the “B-Running” service. This service is published by starter 134 to indicate that Application B is up and running. Similarly to the B-Launch service, this service does not publish any metadata in service discovery since it is only used to indicate that Application B is up and running.

When Application A wants to shut down Application B it sends a SIGTERM signal m214 to what it thinks is Application B, but what is actually proxy 114. Accordingly, Application A may be implemented using the following pseudo-code:

```
int main(void) {
  ...
  event = detect_application_terminate_event( )
  if (event = = TRUE) {
  kill(pid_B);
  kill(pid_C);
  ....
  kill(pid_N);
  }
  ....
}
```

Proxy 114 detects that it has received the SIGTERM signal, but it does not terminate immediately, instead it unpublishes the B-Launch service and starts to wait for the B-Running service to disappear. That is, the proxy transmits to discovery server 122 an unpublish message m216 that identifies the B-Launch service. In response to receiving unpublish message m216, discovery server 122 sends to starter 134 a notification message m218 indicating that the B-Launch service has been unpublished, which causes starter 134 to send a SIGTERM signal m220 to Application B, which is possible since they run in the same cloud container and which causes Application B to terminate gracefully. Application B then terminates, and when starter 134 detects that Application B has terminated, starter 134 unpublishes the B-Running service. That is, starter 134 sends to discovery server 122 an unpublish message m222 identifying the B-Running service, which causes discovery server 122 to transmit to the proxy a notification message m224 informing proxy that the B-Running service has been unpublished, which serves as the notification that Application B has terminated.

In response to receiving the notification message m224, which indicates that Application B has terminated, the proxy will terminate itself, which event is detected by Application A. Application A then simply thinks that it has detected that Application B has terminated and can start to act on that knowledge, even though in reality it is proxy 114 that has terminated. But since Application B has terminated before proxy 114, it is correct by Application A to start to act has if Application B has terminated when proxy 114 has terminated.

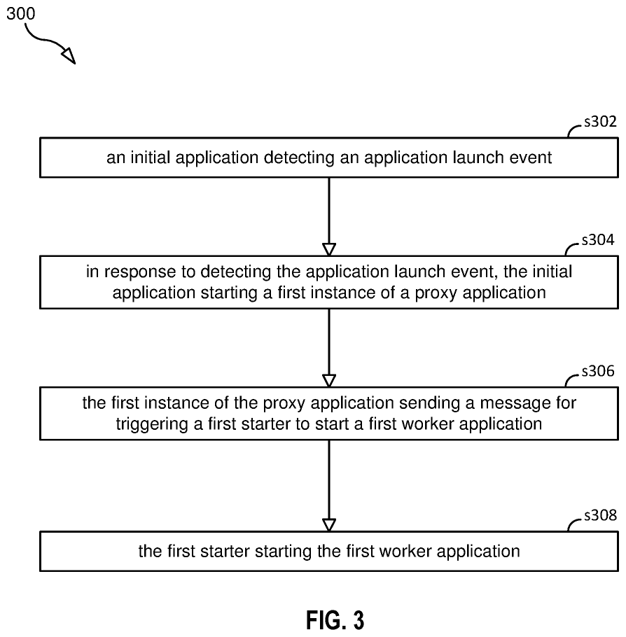

FIG. 3 is a flow chart illustrating a process 300, according to an embodiment, for synchronizing the startup of applications. Process 300 may begin in step s302. Step s302 comprises initial application 112 detecting an application launch event. Step s304 comprises, in response to detecting the application launch event, the initial application starting a first instance of a proxy application 114. Step s306 comprises the first instance of the proxy application sending a message for triggering a first starter (e.g., starter 134) to start a first worker application (e.g., Application B). Step s308 comprises the first starter starting the first worker application.

In some embodiments, the initial application starts the first instance of the proxy application by creating a child process (e.g., initial application call fork ( ) function), wherein the child process executes a file (e.g., the child process executes a binary file by calling the exec ( ) function), and the execution of the file starts the first instance of the proxy application.

In some embodiments, sending a message for triggering the first starter to start the first worker application comprises the first instance of the proxy sending to discovery server 122 a publish message associated with a launch service associated with the first worker application. In some embodiments process 300 also includes the discovery server, in response to receiving the publish message, transmitting to the first starter a notification message indicating that the discovery server received the publish message associated with the first worker application.

In some embodiments process 300 also includes the first starter sending a subscribe message to subscribe to the launch service.

In some embodiments, the initial application and the first instance of the proxy application run within a first container (e.g., container 101), and the starter and the worker application run within a second container (e.g., container 103) that is distinct from the first container. Network node 100 may comprise a first processor for executing the first container and a second processor for executing the second container. The first processor and second processor may be co-located in a single computer (e.g., a single blade server) or the first processor and second processor are in separate computers, and these separate computers do not need to be in the same location or same data center.

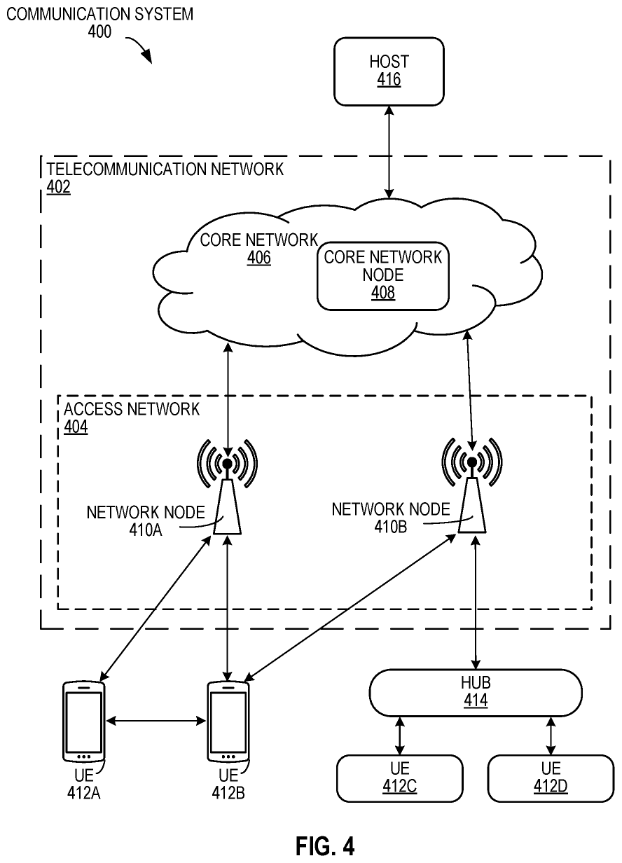

FIG. 4 shows an example of a communication system 400 in accordance with some embodiments.

In the example, the communication system 400 includes a telecommunication network 402 that includes an access network 404, such as a radio access network (RAN), and a core network 406, which includes one or more core network nodes 408. The access network 404 includes one or more access network nodes, such as network nodes 410a and 410b (one or more of which may be generally referred to as network nodes 410), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 402 includes one or more Open-RAN (ORAN) network nodes. An ORAN network node is a node in the telecommunication network 402 that supports an ORAN specification (e.g., a specification published by the O-RAN Alliance, or any similar organization) and may operate alone or together with other nodes to implement one or more functionalities of any node in the telecommunication network 402, including one or more network nodes 410 and/or core network nodes 408. Network node 100 described above may be a core network node, an access network node (e.g., node 410a or 410b), an ORAN network node, etc.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 410 facilitate direct or indirect connection of user equipment (UE), such as by connecting UEs 412a, 412b, 412c, and 412d (one or more of which may be generally referred to as UEs 412) to the core network 406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 400 may include any number of wired or wireless networks, network nodes, UEs, and/or any other components or systems that may facilitate or participate in the communication of data and/or signals whether via wired or wireless connections. The communication system 400 may include and/or interface with any type of communication, telecommunication, data, cellular, radio network, and/or other similar type of system.

The UEs 412 may be any of a wide variety of communication devices, including wireless devices arranged, configured, and/or operable to communicate wirelessly with the network nodes 410 and other communication devices. Similarly, the network nodes 410 are arranged, capable, configured, and/or operable to communicate directly or indirectly with the UEs 412 and/or with other network nodes or equipment in the telecommunication network 402 to enable and/or provide network access, such as wireless network access, and/or to perform other functions, such as administration in the telecommunication network 402.

In the depicted example, the core network 406 connects the network nodes 410 to one or more hosts, such as host 416. These connections may be direct or indirect via one or more intermediary networks or devices. In other examples, network nodes may be directly coupled to hosts. The core network 406 includes one more core network nodes (e.g., core network node 408) that are structured with hardware and software components. Features of these components may be substantially similar to those described with respect to the UEs, network nodes, and/or hosts, such that the descriptions thereof are generally applicable to the corresponding components of the core network node 408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 416 may be under the ownership or control of a service provider other than an operator or provider of the access network 404 and/or the telecommunication network 402, and may be operated by the service provider or on behalf of the service provider. The host 416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 400 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 402 is a cellular network that implements 3GPP standardized features. Accordingly, the telecommunications network 402 may support network slicing to provide different logical networks to different devices that are connected to the telecommunication network 402. For example, the telecommunications network 402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 412 are configured to transmit and/or receive information without direct human interaction. For instance, a UE may be designed to transmit information to the access network 404 on a predetermined schedule, when triggered by an internal or external event, or in response to requests from the access network 404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 414 communicates with the access network 404 to facilitate indirect communication between one or more UEs (e.g., UE 412c and/or 412d) and network nodes (e.g., network node 410b). In some examples, the hub 414 may be a controller, router, content source and analytics, or any of the other communication devices described herein regarding UEs. For example, the hub 414 may be a broadband router enabling access to the core network 406 for the UEs. As another example, the hub 414 may be a controller that sends commands or instructions to one or more actuators in the UEs. Commands or instructions may be received from the UEs, network nodes 410, or by executable code, script, process, or other instructions in the hub 414. As another example, the hub 414 may be a data collector that acts as temporary storage for UE data and, in some embodiments, may perform analysis or other processing of the data. As another example, the hub 414 may be a content source. For example, for a UE that is a VR headset, display, loudspeaker or other media delivery device, the hub 414 may retrieve VR assets, video, audio, or other media or data related to sensory information via a network node, which the hub 414 then provides to the UE either directly, after performing local processing, and/or after adding additional local content. In still another example, the hub 414 acts as a proxy server or orchestrator for the UEs, in particular if one or more of the UEs are low energy IoT devices.

The hub 414 may have a constant/persistent or intermittent connection to the network node 410b. The hub 414 may also allow for a different communication scheme and/or schedule between the hub 414 and UEs (e.g., UE 412c and/or 412d), and between the hub 414 and the core network 406. In other examples, the hub 414 is connected to the core network 406 and/or one or more UEs via a wired connection. Moreover, the hub 414 may be configured to connect to an M2M service provider over the access network 404 and/or to another UE over a direct connection. In some scenarios, UEs may establish a wireless connection with the network nodes 410 while still connected via the hub 414 via a wired or wireless connection. In some embodiments, the hub 414 may be a dedicated hub—that is, a hub whose primary function is to route communications to/from the UEs from/to the network node 410b. In other embodiments, the hub 414 may be a non-dedicated hub—that is, a device which is capable of operating to route communications between the UEs and network node 410b, but which is additionally capable of operating as a communication start and/or end point for certain data channels.

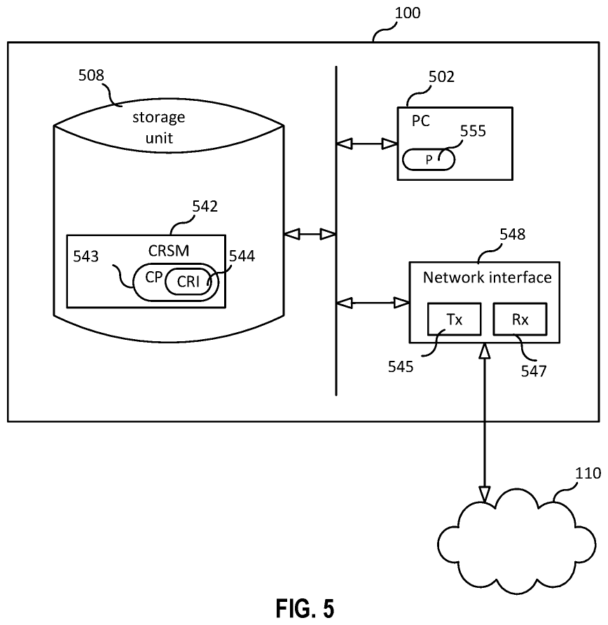

FIG. 5 is a block diagram of network node 100, according to some embodiments. As shown in FIG. 5, network node 100 may comprise: processing circuitry (PC) 502, which may include one or more processors (P) 555 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., network node 100 may be a distributed computing apparatus); at least one network interface 548 (e.g., a physical interface or air interface) comprising a transmitter (Tx) 545 and a receiver (Rx) 547 for enabling network node 100 to transmit data to and receive data from other nodes connected to a network 110 (e.g., an Internet Protocol (IP) network) to which network interface 548 is connected (physically or wirelessly) (e.g., network interface 548 may be coupled to an antenna arrangement comprising one or more antennas for enabling network node 100 to wirelessly transmit/receive data); and a storage unit (a.k.a., “data storage system”) 508, which may include one or more non-volatile storage devices and/or one or more volatile storage devices. In embodiments where PC 502 includes a programmable processor, a computer readable storage medium (CRSM) 542 may be provided. CRSM 542 may store a computer program (CP) 543 comprising computer readable instructions (CRI) 544. CRSM 542 may be a non-transitory computer readable medium, such as, magnetic media (e.g., a hard disk), optical media, memory devices (e.g., random access memory, flash memory), and the like. In some embodiments, the CRI 544 of computer program 543 is configured such that when executed by PC 502, the CRI causes network node 100 to perform steps described herein (e.g., steps described herein with reference to the flow charts). In other embodiments, network node 100 may be configured to perform steps described herein without the need for code. That is, for example, PC 502 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-16. (canceled)

17. A method for synchronizing the startup of applications, the method comprising:
an initial application detecting an application launch event;
in response to detecting the application launch event, the initial application starting a first instance of a proxy application;
the first instance of the proxy application sending a message for triggering a first starter to start a first worker application; and
the first starter starting the first worker application.

18. The method of claim 17, wherein the initial application starts the first instance of the proxy application by creating a child process, wherein the child process executes a file, and the execution of the file starts the first instance of the proxy application.

19. The method of claim 17, wherein sending a message for triggering the first starter to start the first worker application comprises the first instance of the proxy sending to a discovery server a publish message associated with a launch service associated with the first worker application.

20. The method of claim 19, further comprising the discovery server, in response to receiving the publish message, transmitting to the first starter a notification message indicating that the discovery server received the publish message associated with the first worker application.

21. The method of claim 19, further comprising the first starter sending a subscribe message to subscribe to the launch service.

22. The method of claim 17, wherein the initial application and the first instance of the proxy application run within a first container, and the starter and the worker application run within a second container that is distinct from the first container.

23. A network node, the network node comprising:
an initial application;
a proxy application;
a first worker application; and
a first starter associated with the first worker application, wherein
the initial application is configured to detect an application launch event and is further configured to, in response to detecting the application launch event, start a first instance of the proxy application,
the first instance of the proxy application is configured to send a message for triggering the first starter to start the first worker application, and
the first starter is configured to start the first worker application.

24. The network node of claim 23, wherein the initial application is configured to start the first instance of the proxy application by creating a child process, wherein the child process executes a file, and the execution of the file starts the first instance of the proxy application.

25. The network node of claim 23, wherein the message for triggering the first starter to start the first worker application is a publish message that is transmitted to a discovery server, and the publish message is associated with a launch service associated with the first worker application.

26. The network node of claim 25, wherein the discovery server is further configured to, in response to receiving the publish message, transmit to the first starter a notification message indicating that the discovery server received the publish message associated with the first worker application.

27. The network node of claim 25, wherein the first starter is further configured to send a subscribe message to subscribe to the launch service.

28. The network node of claim 23, wherein the initial application and the first instance of the proxy application run within a first container, and the starter and the worker application run within a second container that is distinct from the first container.

29. The network node of claim 28, further comprising:
a first processor for executing the first container; and
a second processor for executing the second container.

30. The network node of claim 29, wherein the first processor is located in a first data center, and the second processor is located in a second data center.
